(19) United States
(12) Patent Application Publication
(10) Pub. No.: US 2025/0271345 A1
(43) Pub. Date: Aug. 28, 2025

(54) OPTOFLUIDIC SENSOR, WATER-CONDUCTING HOUSEHOLD APPLIANCE AND METHOD FOR DETERMINING A CONCENTRATION

(71) Applicant: ams Sensors Germany GmbH, Jena (DE)

(72) Inventors: Bobby DANIEL, Eindhoven (NL); Boon Chong CHEAH, Geldrop (NL)

(21) Appl. No.: 18/862,397

(22) PCT Filed: Apr. 13, 2023
(86) PCT No.: PCT/EP2023/059625

§ 371 Date: Nov. 1, 2024

(30) Foreign Application Priority Data
May 5, 2022 (DE) 10 2022 111 153.9

(51) Int. Cl. G01N 15/06; A47L 15/42; A47L 15/44; D06F 34/22; D06F 39/02; D06F 103/22; D06F 105/42; G01N 15/00

(52) U.S. Cl. CPC G01N 15/0612; A47L 15/4297; A47L 15/449; D06F 34/22; D06F 39/02; A47L 2401/023; A47L 2501/07; D06F 2103/22; D06F 2105/42; G01N 2015/0053

(57) ABSTRACT

An optofluidic sensor operable to determine a concentration of a detergent component in a fluid includes a waveguide structure with an input optically coupled to a light source and a sensing region that is exposed to the fluid. A detection unit is optically coupled to an output of the waveguide structure and is configured to generate a detection signal based on an amount of light received from the output. A processing unit is configured to determine, from the detection signal received from the detection unit, the concentration of the detergent component in the fluid. The amount of light received from the output depends on a number of particles of the detergent component adsorbed on a surface of the waveguide structure within the sensing region.

The present invention relates to an optofluidic sensor, a water-conducting household appliance and a method for determining a concentration.

### BACKGROUND OF THE INVENTION

Detergents used for cleaning in water-conducting home appliances such as washing machines and dishwashers typically comprise surfactants, builders, bleaches and polymers. Typically, before the beginning of the cleaning process users of the appliance introduce an amount of detergent into the respective appliance, which the user subjectively considers appropriate. Some detergents on their packaging provide a suggestion of how much detergent to add, e.g. by having the user first estimate a load and/or a dirtiness of the items to be cleaned, and then convert this into an amount of detergent to be added, for example in terms of measuring the amount by means of a bottle cap or a spoon. As a result, end users tend to overdose to ensure that the laundry or dishes are cleaned. Overdosing, however, is not environmental as most detergents comprise corrosive or non-biodegradable chemicals.

Moreover, having the user estimate an amount of detergent is a substantially inaccurate method as different loads and degrees of dirtiness require a different dosage of the detergent. Moreover, different detergents, whether in powder or liquid form, feature different concentrations of different surfactants, which are the main cleaning component in a detergent. This in turn leads to a broad spectrum of detergent qualities available on the market. Likewise, detergents that are pre-portioned as capsules or pods result in the same amount of detergent for each washing cycle, hence also not letting a user adjust for different loads or degrees of dirtiness.

Current approaches to more accurately dose detergents in water-conducting home appliances employ a turbidity sensor in combination with a resistance measurement from a motor, e.g. of a washing machine, and a pH sensor. By doing this, a dirtiness of the items within the appliance, their load and the hardness of the water can be monitored, hence enabling a more accurate estimation of the optimal amount of detergent required. This estimation is either communicated to a user, e.g. as a prompt to introduce a specific amount, or an automatic dispenser is controlled based on this estimation.

Nevertheless, none of the existing approaches consider the detergent type or its quality, which as mentioned before can vastly vary. To overcome this limitations, some appliances manufacturers offer detergents that are specifically designed for their appliances such that an optimal dosage can be determined only based on load and degree of dirtiness, for instance. However, only using a single specific detergent is neither user friendly, nor energy efficient or cost effective.

Thus, an object to be achieved is to provide an optofluidic sensor for water-conducting home appliances that monitors an amount of a component of a detergent in a fluid and a method for determining said concentration. A further object is to provide a water-conducting home appliance comprising such an optofluidic sensor.

These objects are achieved with the subject-matter of the independent claims. Further developments and embodiments are described in dependent claims.

### SUMMARY OF THE INVENTION

The improved concept is based on the idea of optically quantifying, for example during a washing cycle, an amount of a cleaning component of the detergent that is dissolved in a liquid, e.g. in water, forming a water-detergent solvent. As detergents differ in terms of a concentration of their contained cleaning component, merely determining a total amount of detergent within the solvent does not suffice. Instead, the present disclosure provides an optofluidic sensor that is operable to directly determine whether a concentration of said cleaning component for the washing cycle is too low, too high, or within an optimal range. The determination is based on measuring a change in an amount of light detected at the output of a waveguide structure, wherein the change is due to particles being adsorbed on a surface of the waveguide structure in an exposed sensing region.

For example, the adsorbed particles cause a local change of the effective refractive index of a waveguide structure within the sensing region, in which the waveguide structure is exposed to the fluid, i.e. it is free of any cladding. Therein, the sensor targets a detergent component that is contained in most, if not all, detergents available on the market, such as a surfactant. Particularly, the improved concept does not rely on any additional marker agents, such as pyrene, that are added to the detergent specifically for the purpose of performing spectroscopic measurements, but instead relies on purely determining a change received light from a waveguide structure due to adsorption of a component of the detergent that is originally contained, e.g. a cleaning component. Moreover, the improved concept provides an optofluidic sensor that can be realized with a small form factor, and has no loose optical components, moving mechanical parts or bulky components.

In an embodiment, an optofluidic sensor that is operable to determine a concentration of a detergent component in a fluid comprises a waveguide structure having an input, an output and a sensing region, wherein the input is optically coupled to a light source for receiving probe light. The waveguide structure is configured to guide the probe light from the input to the output via the sensing region, and the sensing region is exposed to the fluid. The optofluidic sensor further comprises a detection unit that is optically coupled to the output of the waveguide structure and configured to generate a detection signal based on an amount of light received from the output. The processing unit is configured to determine, from the detection signal received from the detection unit, the concentration of the detergent component in the fluid. Therein, the amount of light received from the output of the waveguide structure depends on a number of particles of the detergent component adsorbed on a surface of the waveguide structure within the sensing region.

The waveguide structure is a structure that guides waves such as electromagnetic waves, in particular light, characterized by a minimal loss of energy by restricting the transmission of energy to one direction. For the guiding of light, the waveguide structure typically comprises a waveguide formed from a transparent dielectric material, wherein transparent in this context refers to a wavelength range that comprises a wavelength of the probe light. Waveguides used at optical frequencies, e.g. the visible, UV or NIR domain, are typically dielectric waveguides, characterized by a dielectric material with a high permittivity, and thus high index of refraction, which is surrounded by a material with lower permittivity. Typically, the structure guides optical waves by total internal reflection. An example of an optical waveguide is an optical fiber, for instance.

The waveguide structure comprises a sensing region that is exposed to a fluid in a manner such that particles that are adsorbed on a surface of the waveguide structure within the sensing region locally alter the transmission characteristics at the point of adsorption. This way, an amount of light at the output of the waveguide structure gives information about whether particles are adsorbed on the exposed surface of the waveguide structure within the sensing region and about a number of adsorbed particles. For example, the amount of light received at the output is inversely proportional to a number of particles of the detergent component adsorbed within the sensing region. For example, the sensing region is realized by means of providing the waveguide structure without a cladding in the sensing region. Therefore, the fluid can come into direct contact with the waveguide, e.g. a wave guiding core, in the sensing region. For example, the waveguide structure within the sensing region is dimensioned such that the light at least partially propagates with an evanescent field outside the waveguide structure in the sensing region.

The detection unit comprises a photodetector, e.g. having a photodiode, for converting an electromagnetic signal received from the output of the waveguide structure into an electronic photo signal, wherein the electronic photo signal is proportional to an amount of light received within an integration time of the photodetector. The photodetector can be directly coupled to the output of the waveguide, e.g. as a waveguide-coupled photodetector, or it is coupled to the output via an output coupling element, e.g. a grating coupler. Likewise, the light from the light source is coupled into the waveguide structure at the input either directly from a waveguide-coupled light source or via an input coupling element such as an input grating coupler.

The processing unit is coupled to the detection unit and receives the detection signal from the latter. For example, the processing unit comprises a conversion table, e.g. stored in a memory, for converting a magnitude of the photo signal into the concentration of the detergent component. The waveguide structure, the detection unit and the processing unit can be arranged on a common substrate, e.g. a semiconductor chip substrate formed from silicon. Alternatively, the detection unit and/or the processing unit can be external and thus not formed on a common substrate.

In an embodiment, the optofluidic sensor further comprises the light source configured to emit the probe light. For ensuring that probe light at a desired optical wavelength is provided, the optofluidic sensor can comprise said light source. The light source can be arranged on a common substrate alongside the waveguide structure and the detection unit such that optimal coupling is ensured at the input between the light source and the waveguide structure, and at the output between the waveguide structure and the detection unit. For example, grating couplers are arranged at the input and output for coupling light into and out of the waveguide structure.

In an embodiment, the light source is a laser, in particular a VCSEL or an edge-emitting laser. Semiconductor lasers such as VCSELs and edge-emitters are space conservative and can be easily integrated together with a photonic-integrated circuit, PIC, comprising the waveguide structure on a common substrate. In addition, VCSELs and edge-emitting lasers can be engineered to output light at a predetermined wavelength and with a predetermined linewidth such that the operation of the optofluidic sensor can be optimized. For example, the laser is characterized by being a single-mode laser emitting light in the NIR regime, e.g. at or around 940 nm.

In an embodiment, an effective refractive index of the waveguide structure within the sensing region depends on the number of adsorbed particles. For example, the optofluidic sensor is an optofluidic refractometer, wherein adsorption of the particles of the detergent component within the sensing region locally alters the effective refractive index of the waveguide structure. The change in refractive index in turn can alter an effective optical path length. The optofluidic sensor can be configured to alter an amount of light received at the output depending on the change in refractive index within the sensing region. Therein a larger number of particles adsorbed on a surface of the waveguide structure within the sensing region can lead to an increased change of the effective refractive index. For example, the probe light propagating through the sensing region is superpositioned with reference light from the same light source that has not propagated through the sensing region in order to establish an interference signal at the output of the waveguide structure. Alternatively, the sensing region can be part of the resonator characterized by a resonance wavelength that depends on an effective refractive index of the sensing region. Thus, an amount of light within the resonator can depend on an amount of particles adsorbed on a surface of the sensing region.

In an embodiment, the waveguide structure at least in the sensing region comprises an oxide interface. Preferably, a surface of the waveguide structure within the sensing region is engineered such that adsorption of the target detergent component is enhanced. Specifically for detergent surfactants oxide interfaces have proven to promote their adsorption while the adsorption of other molecules is suppressed. Thus, having predominantly surfactant molecules adsorb onto the waveguide surface within the sensing region ensures that a high confidence of a concentration determination of this relevant detergent component is achieved. For example, the waveguide structure at least in the sensing region is formed from a silica, which shows excellent adsorption behavior specifically for surfactants.

In an embodiment, the processing unit is further configured to determine from the detection signal a deviation of the concentration from a critical micelle concentration, CMC, of the component. The CMC is a characteristic property of surfactants, e.g. contained in detergents, and describes the concentration of said surfactant above which micelles form. If the concentration is increased further, substantially all of the molecules that are added become micelles. For example, the CMC of linear alkylbenzene sulfonate, LAS, a surfactant commonly used in detergents, is about 0.65 g/l. Only the formation of micelles render the washing cycle with a detergent effective, as these micelles typically trap hydrophobic contaminants within their center.

Having a concentration below the CMC, all, or at least most, of the surfactant molecules remain individual, resulting in the fact that they will float at the surface of the solvent they are dissolved in, i.e. a water-detergent mixture. This is due to the aforementioned hydrophilic part of the molecules. As consequence, a washing cycle at such a low concentration would not be at all efficient as the surfactant molecules at the surface of the solvent are not able to attach to the contaminant particles of the items to be cleaned, e.g. clothes or dishes, and trap these in the center of micelles for efficient cleaning.

A concentration substantially larger than the CMC is tantamount to a waste of detergent. In other words, an optimal amount of detergent for a washing cycle is reached when the surfactant concentration (approximately) equals the CMC of said surfactant.

Thus, the processing unit in these embodiments is configured to compare the determined concentration of the detergent component to its CMC, and to determine a deviation from this comparison. This deviation in turn gives information about whether an amount of detergent in the solvent is optimal, or too high or too low. In consequence, the processing unit can output a signal indicating said deviation to prompt a user of the water-conducting household appliance, which the fluid analysis system can be part of, to act, e.g. to introduce additional detergent. For example, the amount of light received at the output shows different proportionalities for different concentration regimes. At a low surfactant concentration the adsorption is proportional to the surfactant concentration. In other words, the adsorption density is low enough such that negligible interaction occurs between adsorbed molecules.

This first regime is succeeded by a rapid increase in adsorption in a second regime due to tail-tail interactions of the surfactants as well as due to the onset of bilayer coverage or admicelle formation. Thus, the adsorption increases with concentration as successively less energetic patches fill with admicelles. This second regime, marking the onset of the critical admicelle concentration, CAC, is succeeded by a third regime, in which the adsorption increases more slowly with concentration compared to the second regime, owing to lateral hindrances between adsorbed surfactants and also to heterogeneities in surface potentials. Finally, a fourth regime constitutes a plateau adsorption region where adsorption is constant because the surfactant concentration exceeds the CMC.

In an embodiment, the detergent component is a surfactant. For example, the detergent component is linear alkylbenzene sulfonate, LAS, or any other surfactant used in detergents as cleaning component. Alkylbenzene sulfonates are anionic surfactants comprising a hydrophilic sulfonate head-group and a hydrophobic alkylbenzene tail-group. Alkylbenzene sulfonates, particularly LAS, represent the most widely used surfactants employed in laundry detergents and dishwashing liquid. Therein, the term linear in LAS refers to the starting alkene. LAS is found to biodegrade rather quickly, making it an environmental choice of surfactant.

In an embodiment, the optofluidic sensor further comprises a microfluidic channel having an inlet and an outlet so as to provide a fluid path for the fluid, wherein the sensing region is fluidically connected to the microfluidic channel. In order to bring the fluid into contact with the waveguide structure within the sensing region, a microfluidic channel can be employed. For example, in the sensing region, the microfluidic channel is delimited by the exposed surface of the waveguide structure such that adsorption of the detergent component is enabled. The optofluidic sensor can further comprise a flow controller for controlling a flow of the fluid through the microfluidic channel. For example, a flow rate can be increased during a cleaning phase in order to remove particles and molecules adsorbed on the exposed surface of the waveguide structure, while during a sensing phase, a lower flow rate can be set in order to allow the detergent component molecules to adsorb onto the surface.

In an embodiment, the waveguide structure realizes a Mach-Zehnder interferometer having a reference arm and a sensing arm, wherein the sensing region is an exposed portion of the sensing arm. As adsorbed particles locally alter the effective refractive index of the waveguide structure within the sensing region, an effective optical path length is in turn altered. As those changes can be miniscule particularly for low concentrations of the detergent component, an optical interferometer owing to the extreme sensitivity constitutes an effective mean to detect changes in the optical path length. To this end, a Mach-Zehnder type interferometer can be employed, in which input light from the light source is split into a sensing arm and into a reference arm. A portion of the sensing arm within a sensing region is exposed to the fluid such that molecules can be adsorbed on its surface, while the reference arm either comprises a protective cladding or is not brought in contact with the fluid. The light from the sensing and reference arm is combined before the output such that an interferometric signal can form indicating a degree of change of the optical path length due to adsorption.

For example, the waveguide structure comprises an input waveguide, a beam splitter, a beam combiner and an output waveguide. The input waveguide optically couples the input of the waveguide structure to the beam splitter, and the output waveguide optically couples the beam combiner to the output of the waveguide structure. The beam splitter is configured to optically couple the probe light into the sensing arm and the reference arm at a fixed ratio, and the beam combiner is configured to optically couple the probe light from the sensing arm and from the reference arm into the output waveguide. This realizes the aforementioned Mach-Zehnder type interferometer and enables the accurate detection of a local change in refractive index within the sensing region due to adsorption of particles. However, alternative interferometer types, such as a Michaelson-type interferometer also fulfill the improved concept and are therefore likewise possible.

In an embodiment, an effective optical path length of the sensing arm depends on a number of particles adsorbed on the surface of the sensing arm within the sensing region. The aforementioned degree of change of the optical path length directly depends on a degree of change of the effective refractive index within the sensing region. As the latter directly depends on a number of particles adsorbed on the surface, the interferometric signal carries direct information about a number of particles adsorbed on a surface of the sensing arm of the waveguide structure within the sensing region.

In an embodiment, the waveguide structure comprises a signal waveguide optically coupling the light source to the detection unit and having a coupling region, and a whispering gallery mode, WGM, resonator optically coupled to the coupling region such that at least some of the probe light from the light source is coupled into and out of at least one of the whispering gallery modes. The sensing region is an exposed portion of the WGM resonator. Alternatively to the interferometric setup above, the optofluidic sensor can be configured to determine the change in optical path length due to the change in refractive index caused by the adsorption from a center wavelength of a resonator. For example, the probe light has an optical wavelength that corresponds to a whispering gallery mode of the WGM resonator in case of no adsorbed particles.

If the WGM resonator has a sensing region, in which particles can adsorb onto a surface of the resonator, the refractive index is locally changed at the point of adsorption. This leads to the fact that the effective optical path length of the entire resonator changes such that the probe light that matches the intrinsic WGM no longer exactly matches the actual resonance. Therein, the shift of the resonance frequency of the WGM is proportional to a degree of change of the refractive index, and hence to an amount of particles adsorbed. Hence, less probe light is coupled into the WGM resonator the further the resonance frequency shifts such that an amount of light detected at the output gives information about the resonance frequency shift, i.e. the detuning, of the WGM mode and hence to an amount of adsorbed particles or molecules. Alternatively, the wavelength of the probe light can be adjusted to match the shifting resonance frequency, such that an amount of adsorbed particles can be directly derived from the resonance wavelength of the probe light.

In an embodiment, the WGM resonator is a micro-ring resonator. For example, the WGM resonator is formed from a waveguide that constitutes a ring structure. For example, the resonator is formed from a ring-shaped silica waveguide, e.g. formed from silicon dioxide. Silicon dioxide enhances the adsorption of surfactants as mentioned above. Hence, an extremely sensitive measurement scheme that detects a shift in resonance frequency of a WGM can be realized for determining a concentration of the detergent component, e.g. a surfactant.

In an embodiment, the sensing region is formed by the entire WGM resonator being exposed. If the entire WGM resonator is the sensing region, i.e. the refractive index is sensitive to adsorption of molecules along the entire circumference of the resonator, the measurement accuracy and determination of the concentration can be greatly enhanced.

In an embodiment, an amount of light coupled from the WGM resonator into the signal waveguide depends on a number of particles adsorbed on the surface of the WGM resonator within the sensing region. For example, the probe light is kept at a constant wavelength throughout the sensing phase. Upon adsorption of molecules in the sensing region, the effective refractive index changes locally, leading in turn to an alteration of the effective optical path length at this location. As more and more particles adsorb onto the surface of the resonator within the sensing region, this local change increases and/or the region of refractive index change is increased. Hence, a larger number of adsorbed particles results in a larger shift of the optical path length of the resonator and hence to a larger shift of the resonance frequency of a given WGM. With this detuning becoming larger, a coupling efficiency of the probe light, still tuned to the intrinsic WGM of the resonator in case of no adsorption, decreases such that less light is coupled into the resonator from the signal waveguide. In other words, an amount of light received at the output is inversely proportional to a detuning of the WGM resonance frequency and hence to a number of adsorbed particles.

In an embodiment, the optofluidic sensor further comprises a flow controller that is configured to control a flow of the fluid in the sensing region. Particularly in embodiments with the microfluidic channel for directing the fluid towards the sensing region of the waveguide structure, a flow controller can be used to ensure a constant flow rate during a sensing phase. This can be essential for accurate determination of the concentration as the adsorption of molecules, e.g. surfactant molecules, is of an electrostatic nature and therefore depends on a flow velocity. Furthermore, a flow can be increased before and/or after a sensing phase in order to remove adsorbed particles from the sensing region.

In an embodiment, the optofluidic sensor comprises a common substrate for the waveguide structure, the detection unit and the processing unit. In particular, the waveguide structure, the detection unit and the processing unit are integrated on the common substrate. In addition, the light source may be integrated on the common substrate. For example, the common substrate comprises or consists of silicon and the waveguide structure, the detection unit, the processing unit and the light source are formed in a complementary metal-oxide-semiconductor (CMOS) compatible process.

For example, the waveguide structure is formed as an integrated photonic circuit in one or more waveguide layers disposed on the common substrate. The waveguide layer forms the waveguide core and comprises or consists of silicon nitride, for example. The waveguide layer may be arranged between two cladding layers comprising an oxide, such as silicon dioxide, for example. The cladding layer facing away from the substrate may be patterned or removed in regions in order to form the sensing region.

For example, the processing unit comprises an electrical circuit integrated with the common substrate, while a detection unit comprises a photodiode integrated with the common substrate. The detection unit and/or the light source may comprise germanium (Ge) or silicon-germanium (SiGe) for emission and/or detection of light in the NIR regime. In particular, Ge and SiGe can be incorporated into a CMOS compatible manufacturing process.

Furthermore, a water-conducting household appliance is provided that comprises an optofluidic sensor according to one of the embodiments described above. This means that all features disclosed for the fluid analysis system are also disclosed for and applicable to the water-conducting household appliance and vice-versa. For example, the water-conducting household appliance is a washing machine or a dishwasher. The term home appliance is used to describe the nature of the appliances and does not limit an application purely to end consumers. In contrast, also industrial and commercial water-conducting appliances can benefit from the improved concept.

In some embodiments, the water-conducting household appliance further comprises a detergent dispenser having a controller, wherein the controller is coupled to the optofluidic sensor and is configured to control a dispensing of detergent based on the determined concentration received from the optofluidic sensor. The concentration of a surfactant and optionally also of a brightener determined by the fluid analysis system can be used to ensure an optimal amount of detergent within the appliance during a washing cycle, e.g. within a drum of a washing machine. To this end, the determined concentration can be used as a control signal of a detergent dispenser.

Furthermore, a method for determining a concentration of a detergent component in a fluid is provided. The method comprises providing a waveguide structure having an input, an output and a sensing region that is exposed to the fluid, the waveguide structure being configured to guide probe light from the input to the output via the sensing region. The method further comprises optically coupling the input to a light source for receiving the probe light, optically coupling a detection unit to the output of the waveguide structure, and generating, by means of the detection unit, a detection signal based on an amount of light received from the output. The method further comprises determining, by means of a processing unit, from the detection signal received from the detection unit the concentration of the detergent component in the fluid. Therein, the amount of light received from the output depends on a number of particles of the detergent component adsorbed on a surface of the waveguide structure within the sensing region.

Further embodiments of the method become apparent to the skilled reader from the embodiments of the optofluidic sensor described above, and vice-versa.

### BRIEF DESCRIPTION OF THE DRAWINGS

The following description of figures may further illustrate and explain aspects of the optofluidic sensor and the method for determining a concentration of a detergent component in a fluid. Components and parts of the optofluidic sensor that are functionally identical or have an identical effect are denoted by identical reference symbols. Identical or effectively identical components and parts might be described only with respect to the figures where they occur first. Their description is not necessarily repeated in successive figures.

### DETAILED DESCRIPTION

In the figures:

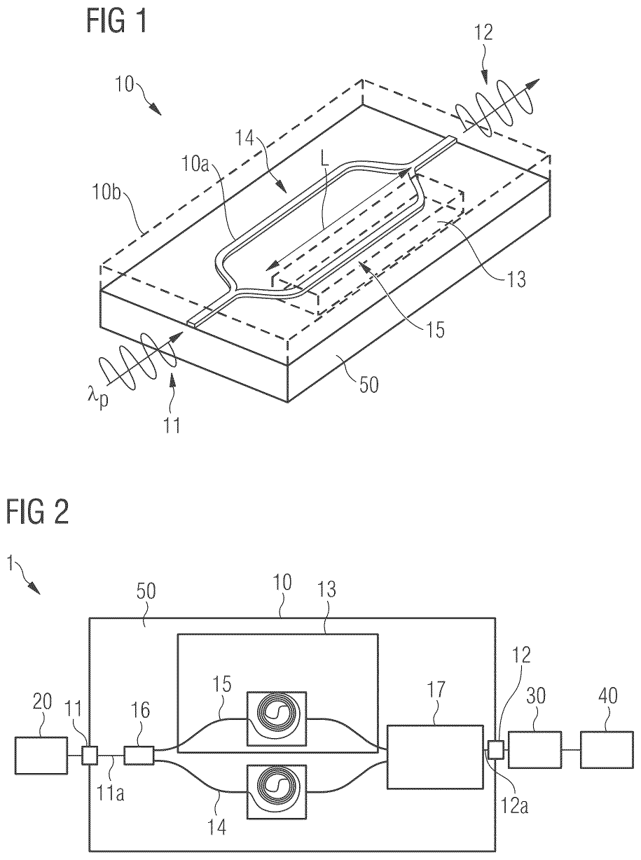

FIG. 1 shows a first exemplary embodiment of a waveguide structure of an optofluidic sensor according to the improved concept;

FIG. 2 shows a first exemplary embodiment of an optofluidic sensor comprising a waveguide structure;

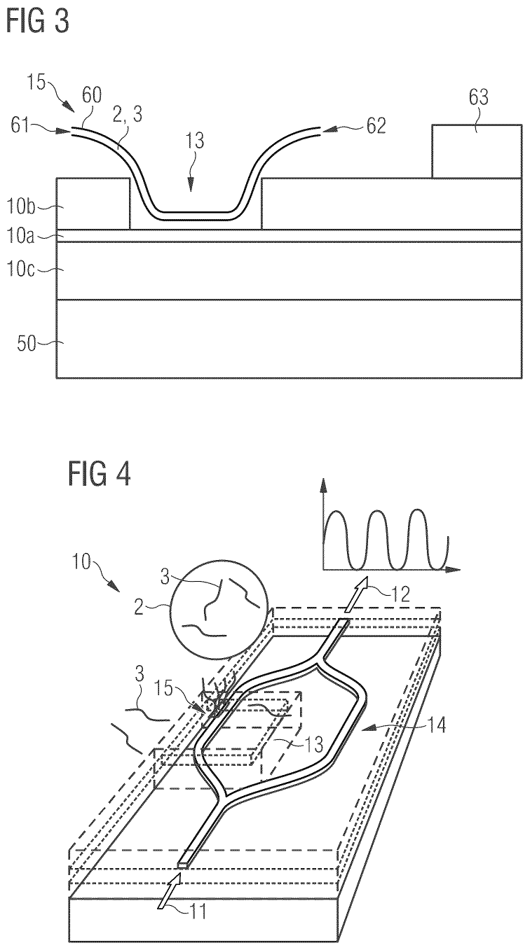

FIG. 3 shows a cross-sectional schematic view of a an exemplary embodiment of a waveguide structure;

FIG. 4 illustrates the working principle of an optofluidic sensor according to the improved concept;

FIG. 5 shows a second exemplary embodiment of a waveguide structure of an optofluidic sensor according to the improved concept;

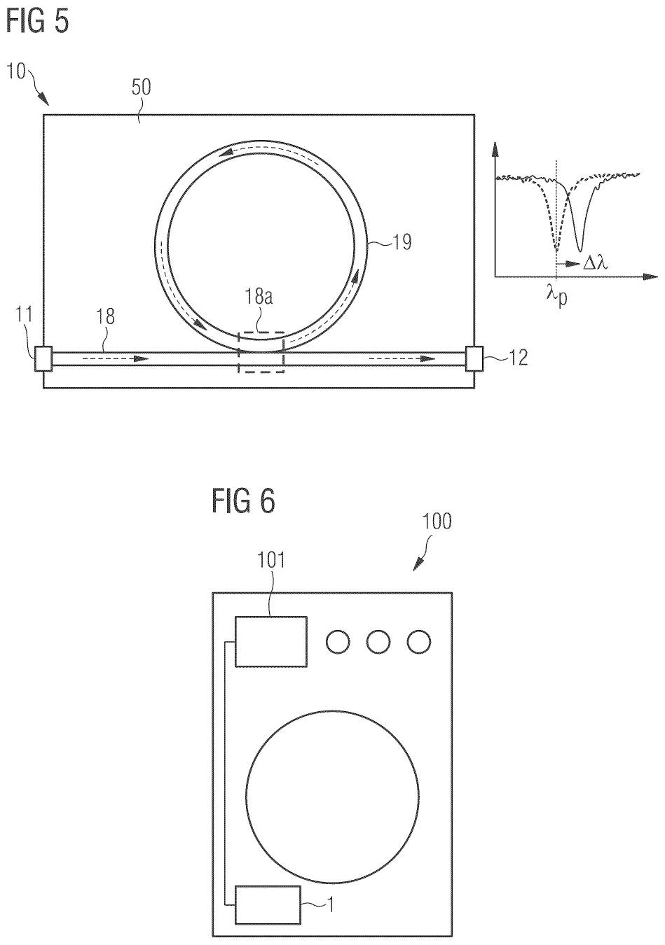

FIG. 6 shows an exemplary embodiment of a water-conducting household appliance; and

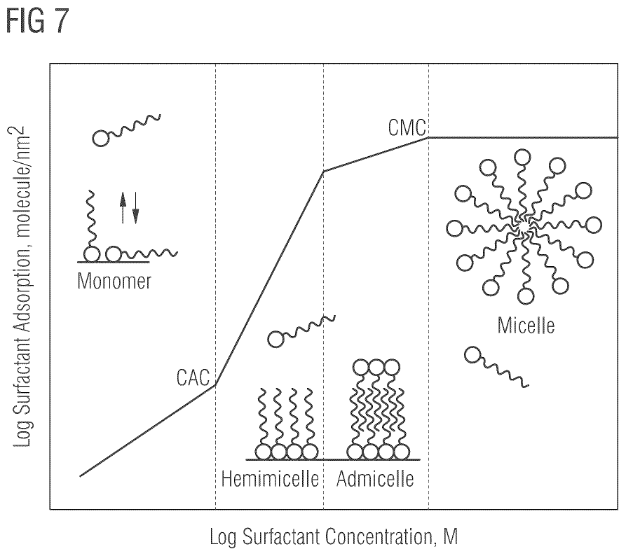

FIG. 7 shows a graph illustrating the adsorption behavior versus concentration of the detergent component.

FIG. 1 shows a first exemplary embodiment of a waveguide structure 10 of an optofluidic sensor 1 according to the improved concept. In this embodiment, the waveguide structure 10 realizes a waveguide-based Mach-Zehnder type optical interferometer arranged in between an input 11 and an output 12 of the waveguide structure 10. For forming the interferometer, the probe light, characterized by an optical wavelength λₚ, received at the input 11 of the waveguide structure is split into a reference arm 14 and a sensing arm 15. For example, the splitting occurs at a fixed ratio, e.g. a 1:1 ratio. After propagating through the reference arm 14 or the sensing arm 15, the light is recombined before being guided to an output 12 of the waveguide structure 10.

The reference arm 14 and the sensing arm 15 differ from each other in that at least a portion of the waveguide 10a of the sensing arm 15 comprises a sensing region 13, which is exposed to a fluid 2 such that particles 3 of the fluid 2, e.g. molecules of a surfactant, can adsorb to a surface of a waveguide 10a of the waveguide structure 10 within the sensing region 13. For example, as illustrated in FIG. 1, the waveguides 10a of the waveguide structure 10 are covered by a cladding layer 10b except for a portion of the sensing arm 15 that is exposed to an environment of the waveguide structure and thus defines the sensing region 13. The sensing region 13 is defined by a length L of the recess formed within the cladding layer 10b.

The waveguide structure 10 in this embodiment further comprises a substrate 50, e.g. a semiconductor chip substrate, wherein the waveguides 10a are formed on a surface of the substrate 50 as a photonic integrated circuit, PIC, for instance. Alternatively, the waveguide structure 10 can be formed from optical fibers, wherein the sensing region 13 is formed by removing a cladding of the optical fiber within the sensing region 13 and optionally thinning a core of the waveguide by means of tapering, for instance. For coupling light into the waveguide structure 10, the input 11 can comprise a coupling element, such as a grating coupler, for transitioning between free space from light source 20 and a waveguide 10a. Likewise, the output 12 can comprise a coupling element for transitioning between the waveguide 10a and free space for directing light towards a detection unit of the optofluidic sensor 1.

The waveguide 10a within the sensing region 13 of the sensing arm 15 is engineered such that particles 3 from a liquid 2 the sensing region 13 is exposed to can adsorb on a surface of the waveguide 10a. Moreover, the waveguide 10a within the sensing region 13 is engineered such that adsorbed particles at least locally alter an effective refractive index of the waveguide 10a. Thus, particles 3 adsorbed on the waveguide 10a alter an effective optical path length of the sensing arm such that an interferometric signal after recombination is generated, which carries information about an effective path length difference between the reference arm 14 and the sensing arm 15. Comparing this in turn to an intrinsic path length difference, e.g. the intrinsic optical path lengths of the reference arm 14 and the sensing arm 15 are identical, thus gives information on whether particles 3 are adsorbed on a surface of the waveguide 10a within the sensing region 13. Moreover, as a larger number of adsorbed particles 3 increasingly alters an effective refractive index of the sensing arm 15, the interferometric signal at the output 12 likewise carries information about a number of particles 3 adsorbed on a surface of the waveguide 10a within the sensing region 13. This in turn gives information about a concentration of said particles 3 within the fluid 2. For example, the surface of the waveguide 10a predominantly adsorbs a single type of particles 3 within the fluid 2, e.g. surfactant molecules.

FIG. 2 shows a first exemplary embodiment of an optofluidic sensor 1 comprising a waveguide structure 10 similar to that presented in FIG. 1. The optofluidic sensor 1 comprises a waveguide structure 10 realizing a Mach-Zehnder type interferometer having an input waveguide 11a that couples the input 11, e.g. a grating or waveguide coupler, to a beam splitter 16. The beam splitter 16 splits the probe light from the light source 20 into the reference arm 14 and the sensing arm 15. The sensing arm 15 is characterized by having a sensing region 13 that is exposed to a surrounding of the optofluidic sensor 1, e.g. to a fluid 2 containing particles 3 of a component, of which the concentration is to be determined. The sensing region 13 is illustrated as a rectangular recess in a protective cladding 10b (cf. FIGS. 1 and 3). A beam combiner 17, i.e. a splitter operated in reverse, recombines light from the reference arm 14 and the sensing arm 15 and couples the superpositioned signal into an output waveguide 12a that couples the beam combiner 17 to the output 12 of the waveguide structure 10.

The optofluidic sensor 1 further comprises a light source 20, e.g. a laser, which is configured to output probe light at a wavelength to the input 11 of the waveguide structure 10. For example, the light source 20 is a semiconductor laser such as an edge-emitter or a vertical cavity surface emitting laser, VCSEL. The optofluidic sensor 1 further comprises a detection unit 30 coupled to the output 12 and configured to receive the superposition signal from the output waveguide 12a. For example, the detection unit 30 comprises a photodetector that converts the optical superposition signal into an electronic detection signal. This signal is provided to a processing unit 40 of the optofluidic sensor 1 for determining the particle concentration of the fluid 2, i.e. the concentration of the detergent component within a detergent-water solvent. For example, the processing unit 40 determines from the detection signal a number of adsorbed particles 3 and consequently from the determined number a concentration of the detergent component in the fluid 2. For the latter step, the processing unit 40 can be configured to determine the concentration also from a flow rate of the fluid 2.

Though only the waveguide structure is indicated to be arranged on a substrate 50 while the light source 20, the detection unit 30 and the processing unit 40 are separate components in this embodiment, alternatively all or at least some of these components can be arranged on a common substrate 50 realizing an integrated, e.g. fully integrated, photonic circuit device.

FIG. 3 shows a cross-sectional schematic view of a portion of the sensing arm 15 of the exemplary embodiment of a waveguide structure 10 of FIGS. 1 and 2. The figure shows the waveguide structure 10 being arranged on a substrate 50, e.g. a silicon substrate. On a top surface of the substrate 50, a dielectric buffer layer 10c is arranged, for example formed from a silica, such as silicon dioxide, which is deposited by means of a high-density plasma chemical vapor deposition process, HDP CVD. On a top surface of the buffer layer 10c, a structured and/or patterned layer is arranged for forming the waveguide core 10a. For example, the waveguide core 10a is formed from silicon nitride and has a thickness of 100-500 nm, in particular 250 nm. On a top surface of the waveguide 10a, a cladding layer 10b is arranged, e.g. silicon dioxide deposited via a sputtering process. Therein, a recess is defined leaving a portion of the waveguide core 10a uncovered by the cladding layer 10b and thus defining the sensing region 13, in which the waveguide core 10a is exposed to an environment, i.e. to the fluid 2 containing particles 3 of the detergent component.

In this embodiment, the optofluidic sensor 1 further comprises a microfluidic channel 60 having an inlet 61 and an outlet 62, wherein the microfluidic channel 60 is configured to guide the fluid 2 to the waveguide core 10a within the sensing region 13 such that the fluid 2 can come into contact with an exposed surface of the waveguide core 10a. To this end, the microfluidic channel can be delimited by the exposed surface of the waveguide core 10a within the sensing region 13. This way, the particles 3 of the detergent component can adsorb on the surface of the exposed waveguide core 10a. The optofluidic sensor 1 can further comprise a flow controller 63 for controlling a flow of the fluid 2 through the microfluidic channel 60. This way, during a sensing phase a flow that is ideal for adsorption of particles 3 can be set, while in other phases a higher flow can be set such that adsorbed particles 3 are removed from the surface of the exposed waveguide core 10a, e.g. before a sensing phase. In alternative embodiments, the sensing region 13 of the optofluidic sensor 1 is exposed to the fluid 2 that surrounds the sensing region 13 without an employment of a microfluidic channel. For example, during a sensing phase the recess forming the sensing region 13 is filled with the fluid 2.

The waveguide core 10a can comprise structured or patterned regions for forming grating couplers and/or Bragg reflectors for coupling of light in and out of the waveguide structure 10 and for controlling a propagation of the light. Likewise, the buffer layer 10c can comprise implants around the structured regions of the waveguide core 10a, e.g. for forming a metal mirror in order to enhance coupling of grating couplers.

FIG. 4 illustrates the working principle of an optofluidic sensor 1 according to the embodiment of FIGS. 1 and 2 employing a Mach-Zehnder type interferometer. As illustrated, the sensing arm 15 of the ach-Zehnder arrangement is partially exposed forming a sensing region 13, in which particles 3 of the detergent component contained in a fluid 2 can adsorb on a surface of the waveguide, i.e. the waveguide core 10a, within the sensing region 13. Adsorbed particles locally alter the effective refractive index of the waveguide by altering the refractive index at the interface between the waveguide core 10a and the fluid 2. This in turn leads to a change in effective optical path length of the sensing arm 15, wherein an increased amount of adsorbed particles 3 results in an increased change in effective optical path length.

For example, the intrinsic optical path length of the sensing arm 15 and the reference arm 14 are identical. Thus, the adsorption of the particles 3 leads to a change in the interferometric signal after recombination and superposition of the light in the reference and sensing arms 14, 15 at the output 12 of the waveguide structure 10. The change in the interferometric signal, converted into an electronic detection signal by means of the detection unit 30, thus carries direct information about a number of adsorbed particles 3, from which a concentration of the detergent component within the fluid 2 can be derived by means of the processing unit 40.

FIG. 5 shows a second exemplary embodiment of a waveguide structure 10 of an optofluidic sensor 1 according to the improved concept. In contrast to the first embodiment relying on a Mach-Zehnder type interferometer, the waveguide structure 10 in this embodiment comprises a signal waveguide 18 that couples the input 11 to the output 12. The waveguide structure further comprises a resonator 19, e.g. a whispering gallery mode (WGM) resonator, which is coupled to the signal waveguide 18 in a coupling region 18a. For example, the signal waveguide 18 and the resonator 19 are evanescently coupled to each other. This means that probe light that matches a resonator mode of the resonator, e.g. a whispering gallery mode, in terms of wavelength is coupled from the signal waveguide 18 into the resonator 19 for circulation, thus decreasing the amount of light propagating to the output 12. The dashed arrows in the figure illustrate the propagation of light. In other words, if a wavelength λₚ matches the resonator mode, a transmission minimum is detected at the output 12 as illustrated by the inset of FIG. 5. If a polarization of the probe light within the coupling region 18a is matched to the resonator mode, all light can be coupled into the resonator 19 leading to zero transmission towards the output 12.

A portion of or the entire resonator 19 can be exposed to a fluid 2 surrounding the optofluidic sensor 1, thus forming the sensing region 13. Similar as in the case of the Mach-Zehnder interferometer, particles 3 adsorbing on the surface of the resonator locally alter the effective refractive index leading in turn to a change in the effective optical path length of the resonator 13. This leads to a shift in the resonance frequency of a given resonator mode, wherein the shift is proportional to a number of particles 3 adsorbed on the resonator 19 within the sensing region 13. For a fixed wavelength λₚ of the probe light provided to the input 11 of the waveguide structure 10 that is tuned to the intrinsic resonance frequency of a WGM, for instance, a shift in the resonance frequency results in a detuning of the probe light and thus to a reduced amount of light that is coupled into the resonator. The inset, illustrating the transmission dip and its shift, shows a transmission signal received at the output 12 versus optical wavelength. As can be seen, the signal at the output 12 increases with larger shift Δλ compared to zero detuning in case of no adsorbed particles 3. Thus, an amount of light detected at the output can be inversely proportional to a number of particles 3 adsorbed on a surface of the resonator 19. From this, the processing unit 40 can again infer a concentration of the detergent component in the fluid 2.

The resonator 19 in this exemplary embodiment is a ring resonator. However, alternative embodiments can rely on any other type of WGM resonator, e.g. disc or toroidal resonators, as well as one-dimensional resonators, such as photonic crystal resonators being delimited by Bragg reflectors on either end, for instance.

FIG. 6 shows an exemplary embodiment of a water-conducting household appliance 100 comprising an optofluidic sensor 1. For example, the household appliance 100 is a washing machine for clothes or a dishwasher. Household appliance in this context also includes industrially and commercially used appliances of the same type. The household appliance 100 comprises an optofluidic sensor 1 according to the improved concept, e.g. according to one of the embodiments described above, wherein the optofluidic sensor 1 is configured to determine a concentration of a surfactant within a fluid 2. For example, the fluid analysis system 1 is arranged such that a water-detergent mixture is probed during recycling of said mixture in between steps of a cleaning cycle, for instance. Thus, the optofluidic sensor 1 is arranged to probe the fluid 2 within a tube or reservoir within the household appliance 100. In conventional approaches, the turbidity sensor is typically placed under the drum of a side-loading washing machine or placed at the drainage of water for top-loading washing machines. A optofluidic sensor 1 according to the improved concept can likewise be placed in a corresponding location such that the sensing region 13 can come into contact with, i.e. it is fluidically coupled to, the fluid 2. Thus, a optofluidic sensor 1 according to the improved concept can be configured to determine the detergent concentration and that of a contaminant after each washing cycle in order to eventually determine the amount of detergent to be added.

The household appliance 100 can further comprise a detergent dispenser 101, which is configured to automatically dispense and add detergent to the solvent within the appliance. For example, the detergent dispenser 101 receives a prompt from the optofluidic sensor 1 to begin or terminate dispensing detergent, wherein said prompt depends on a determined concentration of the detergent component, the further detergent component and/or a deviation from a critical micelle concentration, CMC. Alternatively, the household appliance 100 can comprise means, e.g. a display or acoustic port, for notifying a user of how much detergent to add in order to reach the optimal operation point, i.e. a point close to the CMC of the detergent's surfactant.

The optofluidic sensor 1 can further comprise a pH sensor for determining the hardness of the water. Furthermore, the household appliance 100 can comprise means to determine a resistance of a motor of a drum of a washing machine, for instance, for determining a weight and volume of a load. Thus, the concentration of the surfactant, the pH value, the weight and volume of the load and the turbidity of the fluid can be combined when determining an optimal amount of detergent for a specific wash cycle.

FIG. 7 illustrates the typical adsorption behavior in dependence of a concentration of surfactants within a fluid, e.g. a water-detergent mixture. At a low surfactant concentration, i.e. the surfactants being present as monomers, the adsorption shows a first proportionality to the surfactant concentration. In other words, the adsorption density is low enough such that negligible interaction occurs between adsorbed molecules. This first regime is succeeded by a rapid increase in adsorption in a second regime due to tail-tail interactions of the surfactants as well as due to the onset of bilayer coverage or hemimicelle and admicelle formation. Thus, the adsorption increases with concentration as successively less energetic patches fill with hemimicelles and admicelles. This second regime, marking the onset of the critical admicelle concentration, CAC, is succeeded by a third regime, in which the adsorption increases more slowly with concentration compared to the second regime, owing to lateral hindrances between adsorbed surfactants and also to heterogeneities in surface potentials. Finally, a fourth regime constitutes a plateau adsorption region where adsorption is constant because the surfactant concentration exceeds the CMC.

The embodiments of the optofluidic sensor 1 and the method of determining a concentration of a detergent component disclosed herein have been discussed for the purpose of familiarizing the reader with novel aspects of the idea. Although preferred embodiments have been shown and described, changes, modifications, equivalents and substitutions of the disclosed concepts may be made by one having skill in the art without unnecessarily departing from the scope of the claims.

It will be appreciated that the disclosure is not limited to the disclosed embodiments and to what has been particularly shown and described hereinabove. Rather, features recited in separate dependent claims or in the description may advantageously be combined. Furthermore, the scope of the disclosure includes those variations and modifications, which will be apparent to those skilled in the art and fall within the scope of the appended claims.

The term “comprising”, insofar it was used in the claims or in the description, does not exclude other elements or steps of a corresponding feature or procedure. In case that the terms “a” or “an” were used in conjunction with features, they do not exclude a plurality of such features. Moreover, any reference signs in the claims should not be construed as limiting the scope.

This patent application claims the priority of German patent application DE 10 2022 111 153.9, the disclosure content of which is hereby incorporated by reference.

### References

1 optofluidic sensor
2 fluid
3 particle
10 waveguide structure
10a waveguide core
10b cladding layer
10c buffer layer
11 input
11a input waveguide
12 output
12a output waveguide
13 sensing region
14 reference arm
15 sensing arm
16 beam splitter
17 beam combiner
18 signal waveguide
18a coupling region
19 resonator
20 light source
30 detection unit
40 processing unit
50 substrate
60 microfluidic channel
61 inlet
62 outlet
63 flow controller
100 household appliance
101 controller
Δλ resonance frequency shift
λₚ wavelength of probe light

1. An optofluidic sensor operable to determine a concentration of a detergent component in a fluid, comprising:
a waveguide structure having an input, an output and a sensing region, wherein the input is optically coupled to a light source for receiving probe light, the waveguide structure is configured to guide the probe light from the input to the output via the sensing region, and the sensing region is exposed to the fluid;
a detection unit optically coupled to the output of the waveguide structure and configured to generate a detection signal based on an amount of light received from the output; and
a processing unit configured to determine, from the detection signal received from the detection unit, the concentration of the detergent component in the fluid;
wherein the amount of light received from the output depends on a number of particles of the detergent component adsorbed on a surface of the waveguide structure within the sensing region, and
wherein the waveguide structure, the detection unit and the processing unit are integrated on a common substrate, and
wherein the processing unit is further configured to determine, from the detection signal, a deviation of the concentration from a critical micelle concentration, CMC, of the component.

2. The optofluidic sensor according to claim 1, further comprising the light source configured to emit the probe light.

3. The optofluidic sensor according to claim 1, wherein the light source is a laser, in particular a VCSEL or an edge-emitting laser.

4. The optofluidic sensor according to claim 1, wherein an effective refractive index of the waveguide structure within the sensing region depends on the number of adsorbed particles.

5. The optofluidic sensor according to claim 1, wherein the waveguide structure at least in the sensing region comprises an oxide interface.

6. The optofluidic sensor according to claim 1, wherein the waveguide structure at least in the sensing region is formed from a silica.

7. (canceled)

8. The optofluidic sensor according to claim 1, wherein the detergent component is a surfactant.

9. The optofluidic sensor according to claim 1, further comprising a microfluidic channel having an inlet and an outlet so as to provide a fluid path for the fluid, wherein the sensing region is fluidically connected to the microfluidic channel.

10. The optofluidic sensor according to claim 1, wherein the waveguide structure realizes a Mach-Zehnder interferometer having a reference arm and a sensing arm, wherein the sensing region is an exposed portion of the sensing arm.

11. The optofluidic sensor according to claim 10, wherein the waveguide structure comprises an input waveguide, a beam splitter, a beam combiner and an output waveguide, wherein
the input waveguide optically couples the input of the waveguide structure to the beam splitter;
the output waveguide optically couples the beam combiner to the output of the waveguide structure;
the beam splitter is configured to optically split and couple the probe light into the sensing arm and the reference arm; and
the beam combiner is configured to optically combine and couple the probe light from the sensing arm and from the reference arm into the output waveguide.

12. The optofluidic sensor according to claim 10, wherein an effective optical path length of the sensing arm depends on a number of particles of the detergent component adsorbed on the exposed portion of the sensing arm.

13. The optofluidic sensor according to claim 1, wherein the waveguide structure comprises:
a signal waveguide optically coupling the light source to the detection unit and having a coupling region; and
a whispering gallery mode, WGM, resonator optically coupled to the coupling region such that at least some of the probe light from the light source is coupled into and out of at least one optical whispering gallery mode of the WGM resonator;
wherein the sensing region is an exposed portion of the WGM resonator.

14. The optofluidic sensor according to claim 13, wherein the WGM resonator is a micro-ring resonator.

15. The optofluidic sensor according to claim 13, wherein the sensing region is formed by the entire WGM resonator being exposed.

16. The optofluidic sensor according to claim 13, wherein an amount of light coupled from the WGM resonator into the signal waveguide depends on a number of particles of the detergent component adsorbed on the exposed portion of the WGM resonator.

17. The optofluidic sensor according to claim 1, further comprising a flow controller that is configured to control a flow of the fluid in the sensing region.

18. A water-conducting household appliance comprising an optofluidic sensor according to claim 1.

19. The water-conducting household appliance according to claim 18, further comprising a detergent dispenser having a controller coupled to the optofluidic sensor, wherein the controller is configured to control a dispensing of detergent based on the determined concentration received from the optofluidic sensor.

20. A method for determining a concentration of a detergent component in a fluid, the method comprising:
providing a waveguide structure having an input, an output and a sensing region that is exposed to the fluid, the waveguide structure being configured to guide probe light from the input to the output via the sensing region;
optically coupling the input to a light source for receiving the probe light;
optically coupling a detection unit to the output of the waveguide structure;
generating, by means of the detection unit, a detection signal based on an amount of light received from the output;
determining, by means of a processing unit, from the detection signal received from the detection unit the concentration of the detergent component in the fluid;
wherein the amount of light received from the output depends on a number of particles of the detergent component adsorbed on a surface of the waveguide structure within the sensing region; and
wherein the waveguide structure, the detection unit and the processing unit are integrated on a common substrate; and
wherein the processing unit is further configured to determine, from the detection signal, a deviation of the concentration from a critical micelle concentration, CMC, of the component.
